(19) United States
(12) Patent Application Publication
(10) Pub. No.: US 2008/0115050 A1
(43) Pub. Date: May 15, 2008

(54) SPACE-TIME TRAIL ANNOTATION AND RECOMMENDATION

(75) Inventors: Nuria M. Oliver, Seattle, WA (US); Marc A. Smith, Redmond, WA (US); Scott J. Counts, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/559,794

(22) Filed: Nov. 14, 2006

(51) Int. Cl. G06F 17/30

(52) U.S. Cl. 715/210

(57) ABSTRACT

Space-time trails are annotated automatically and/or manually with meaningful information. Mechanisms are provided for receipt of implicit and/or passive data (e.g., provided by sensors) as well as explicit and/or active data (e.g., provided by users). Extraction techniques are provided to either or both types of data to produce useful information to annotate or otherwise interpret data associated with a space-time trail. Persisted annotated trails can subsequently be employed to glean valuable information. Furthermore, goal-directed recommendations can be generated with respect to annotated trails, among other things.

### BACKGROUND

Computers and other processor-based devices continue to pervade people's lives in ever changing manners. In the not so distant past, computers were the sole domain of large enterprises and well funded researchers. Hardware and software developments as well as cost reductions pushed computers into consumer markets. Initial industry desires to place a computer in every household were at least met, if not far exceeded. Today, most individuals own or have access to multiple computers or like devices. For example, individuals typically utilize one or more computers at work or school as well as at home to perform various tasks such as document production and network interaction.

Further reduction of cost and substantial decreases in component size subsequently fueled a market for much more mobile devices. Bulky desktop computers were rivaled by more mobile laptop computers. Initially meant for traveling professions, many other demographic groups migrated toward the lighter portable computer. Mobile phones also saw a dramatic increase in demand as their size and battery life made them more practical. Other mobile processor-based devices also became popular such as the personal digital assistants (PDAs) and palmtop computers. Most recently, portable digital music players (e.g., MP3 players . . . ) have become the must-have technical gadgets. Further yet, hybrid devices including telephone, PDA and/or music player functionality have begun to emerge in an attempt to become the single mobile device that a user carries.

Today, mobile devices are being designed to be location aware much to the chagrin of staunch privacy advocates. More specifically, user and/or device location technologies are being employed to perform more location-centric tasks. In essence, another mobile device, namely global positioning systems (GPS) or like tracking technology, is being combined with other mobile devices and associated functionality. Such user location information is presently being utilized in a variety of manners. For example, mobile phones can provide user location to emergency services upon dialing of “911.” Further, some mobile phones can utilize this information together with navigation software to help users arrive at their destinations.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to collection, analysis, sharing and presentation of space-time trails. Space-time trails such as routes or paths through space can be generated in a plurality of manners including, by location aware devices, for example. These trails can be annotated with meaningful information. Subsequently, annotated personal trails can be made available to others, for instance via a webpage. Further yet, trails can be recommended to users based on a variety of information.

In accordance with one aspect of the disclosure, space-time trails can be annotated automatically. A collection of at least one sensor can supply data regarding user context including a user's state, environment and/or the like. Meaningful information can be extracted from this data utilizing various algorithms and united with the trail, for instance as metadata.

According to another aspect of the disclosure, annotations can be employed to recommended trails to users and/or community members. More particularly, goal-directed recommendations can be provided. In one instance, a recommendation component can account for user goals and automatically suggest trails that encourage satisfaction of the goals.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a trail annotation system.

FIG. 2 is a block diagram of a trail annotation system adapted for data persistence and/or mining.

FIG. 3 is a block diagram of a trail annotation system including data capture components.

FIG. 4 is a block diagram of a trail annotation system including user interface component.

FIG. 5 is a block diagram of a representative user interface component.

FIG. 6 is a block diagram of a trail recommendation system.

FIG. 7 is a block diagram of a trail system including a context component.

FIG. 8 is a flow chart diagram of a trail annotation method.

FIG. 9 is a flow chart diagram of a method of trail annotation.

FIG. 10 is a flow chart diagram of a recommendation method.

FIG. 11 is a schematic block diagram illustrating a suitable operating environment for aspects of the subject innovation.

FIG. 12 is a schematic block diagram of a sample-computing environment.

### DETAILED DESCRIPTION

Systems and methods are disclosed pertaining to space-time trails. More particularly, the trails can be annotated via automatic and/or manual mechanisms. For example, passive and/or implicit data can be gathered from at least one sensor and active and/or explicit data from users. Various filtering and/or matching techniques can be applied to one or more of the implicit and explicit data to generate meaningful information with which trails can be annotated. The annotations can then be employed to formulate recommendations for a user, or a community of users, with respect to the annotated trails. In one instance, the recommendations can be goal-directed or tailored to aid a user in obtaining at least one designated goal.

Various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

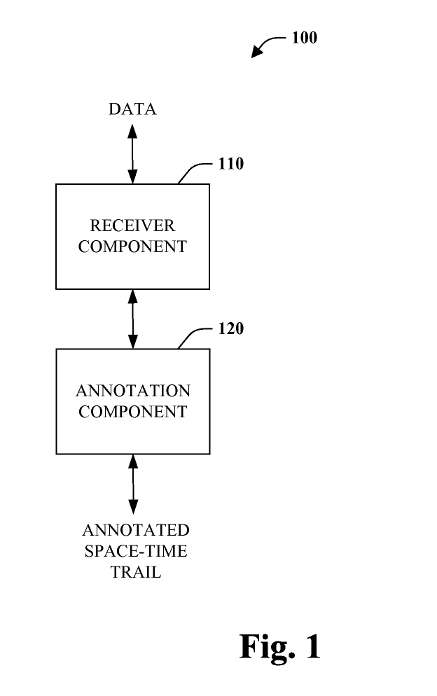

Referring initially to FIG. 1, a space-time trail annotation system 100 is illustrated in accordance with an aspect of this detailed description. The system includes a receiver component 110 and an annotation component 120. Together these components 110 and 120 provide a mechanism to annotate a space-time trail with useful information.

A trail or route is a path including time and space attributes. A space-time trail can correspond to a physical path through space such as an exercise route (e.g., running, jogging, cycling, skating, skiing . . . ), but is not limited thereto. For example, the trail could also correspond to a digital trace with respect to movement through a virtual environment, among other things. The following discussion focuses primarily on physical trails, routes or paths solely to facilitate clarity and understanding of aspects afforded by this detailed description. It should be appreciated, however, that the claimed subject matter is not meant to be limited thereby. Various other applications are contemplated and to be deemed within the scope of the appended claims.

The receiver component 110 receives, retrieves or otherwise obtains or acquires data pertaining to a space-time trail, route or the like. The receiver component 110 thus provides a type of interface between the system 100 and external data provided by at least one source. By way of example and not limitation, a location aware mobile device can generate a trail and acquire data from one or more sensors that collect information about the user (e.g. heart rate . . . ) and/or the environment (e.g., accelerometer, altimeter, temperature . . . ). The receiver component 110 provides or makes available acquired data to the annotation component 120.

The annotation component 120 utilizes data received, retrieved or otherwise obtained from the receiver component 110 to annotate a trail. Annotation refers to adding, linking or otherwise associating data with a trail. In one exemplary implementation, annotations can take the form of metadata associated with a digital representation of a trail (e.g., of type trail). For example, sensor data can be provided as metadata on global positioning system (GPS) route data. The annotation component 120 annotates a trail utilizing the obtained data. In one embodiment, such functionality can be performed automatically. For example, data acquired from the receiver component 110 can initiate automatic trail annotation based thereon. Further yet, note that while a trail may be annotated directly with data obtained from the receiver component 110 this need not be the case. Additionally or alternatively, the annotation component 120 may perform and/or initiate performance of data interpretation to facilitate extraction or derivation of meaningful information from data and annotate a trail with this information, as will be described further infra.

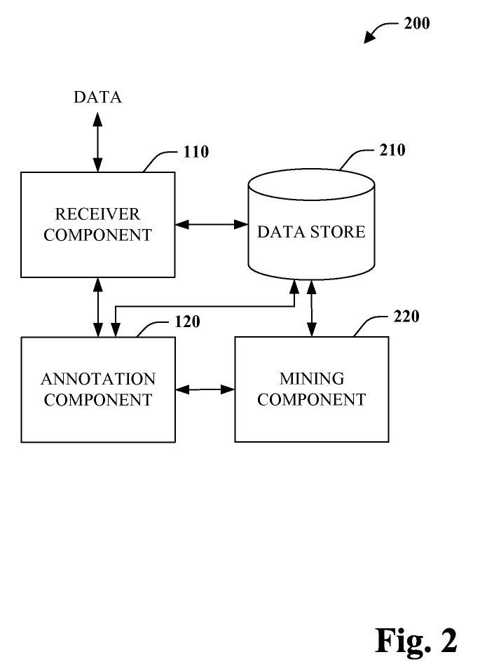

FIG. 2 depicts a trail annotation system 200 in accordance with an aspect of this disclosure. Similar to system 100, system 200 includes the receiver component 110 and annotation component 120, as described above. Briefly, the receiver component 110 makes obtained data available to the component 120, which employs the data to annotate or further define a trail. System 200 also includes a data store 210 to facilitate persistence of acquired data and annotated trails, inter alia. In particular, the receiver component 110 is communicatively coupled to the data store 210 such that acquired data can be persisted thereto. The annotation component 120 can subsequently retrieve the data from the store 210, for instance upon receipt of notification via receiver component 120 that new data is available.

Still further yet, the system 200 includes a data mining component 220 communicatively coupled to the annotation component 120 and the data store 210. The data mining component 220 is operable to analyze and interpret the data associated with a trail to identify valuable and/or meaningful information from the data. For instance, the data mining component 220 can analyze data housed in the store 210 and associated with trails and provide identified information to the annotation component 120 directly or indirectly to facilitate annotation of trails with useful information. In one embodiment, the data mining component 220 can be done utilizing at least one of a myriad of algorithms (e.g., mining, data fusion, machine learning . . . ) tuned to extract meaningful information for particular tasks, states or the like. By way of example in the exercise context, data algorithms may extract a person's pace, road service smoothness and/or cycling cadence from raw acceleration data provided by sensors. Similarly, a person's heart rate may be derived from raw ECG (ElectroCardioGram) data.

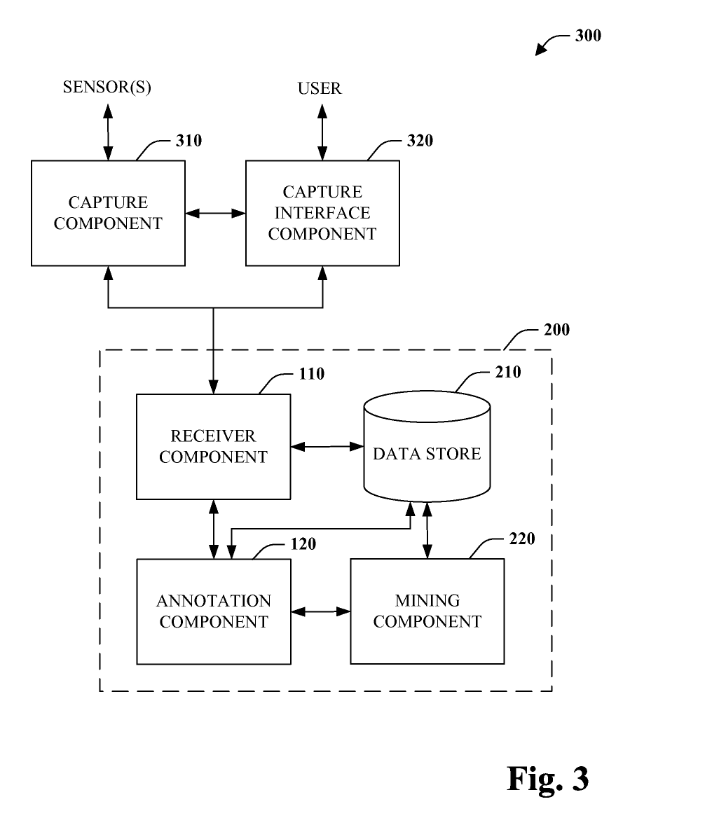

Turning attention to FIG. 3, a trail annotation system 300 is illustrated in accordance with an aspect of the disclosure. System 300 includes an annotation system 200 as described above with respect to FIG. 2. System 200 provides a mechanism for annotating space-time trails. In addition, system 300 includes components 310 and 320 to facilitate data capture and provisioning to system 200. The capture component 310 provides a mechanism to capture data from at least one sensor (e.g., physical or digital). For instance, the sensors can capture information about a user, user equipment and/or the environment. The capture interface component 320 is a mechanism that allows users to control data capture via the capture component 3 10. For example, the interface component 320 may be employed to initiate and halt data capture, among other things. In accordance with an aspect of the disclosure, the capture component 310 and/or capture interface component 320 can be embodied within a mobile device such as but not limited to a mobile phone, digital music player, PDA, hybrid and/or connectable mobile component. Additionally or alternatively, an associated sensor package or box including one or more sensors can be utilized to communicate sensor data back to the mobile device via one or more of a various wire and/or wireless technologies. Yet another addition or alternative can include capture of data from sensors embedded in the users clothing as part of body sensor network.

By way of example and not limitation, consider a scenario in which John is a runner who runs regularly for both recreation and exercise. When John goes running, he carries a mobile phone (e.g., smart phone) with an add-on sensor box. Using an application on his phone, John simply starts and stops a logging application (e.g., capture component 310) at the beginning and end of his runs (e.g., via capture interface component 320). Over the duration of his runs, the sensor box reports time-stamped data back to the application running on the phone, for instance over Bluetooth, other wireless protocol or wired connection. The sensor-derived data can be processed on the device for real-time feedback and/or sent to a central server for processing. John can have his phone configured to report each run to a server over the air whenever he stops logging a route. Thus, he simply presses, “stop logging” on his phone application at the end of his run.

It is to be noted that system 300 can be configured in a myriad of manners. In one instance, a mobile device can include solely components 310 and 320 for capturing data and providing it back to a separate system 200 such as a server for processing. Alternatively, the mobile device can include many of the components identified in system 300 to enable trails to be annotated by the mobile device itself and subsequently persisted locally and/or centrally on data store 210.

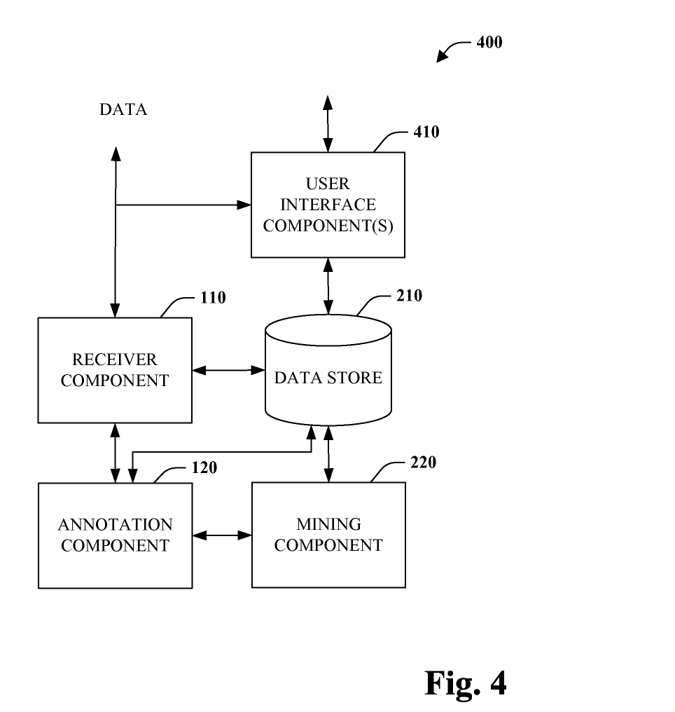

FIG. 4 illustrates a trail annotation system 400 including at least one user interface component. As shown, system 400 includes the receiver component 110, annotation component 120, data store 210 and data mining component 220 previously described. Further provided is user interface component(s) 410 in accordance with an aspect of the disclosure. The user interface component 410 provides a mechanism to enable users to interact with trails, inter alia. The component 410 is communicatively coupled to the data store 210 to facilitate location (e.g., search, browsing . . . ) of persisted trails together with their associated metadata. Furthermore, the user interface component 410 may also be employed to provide input for instance via the data store 210 and/or receiver component 11 0. Still further yet, the component 410 can be utilized to facilitate provisioning of feedback back to users during movement along a trail. One or more user interface components 410 can be resident on a server, mobile device or other computer.

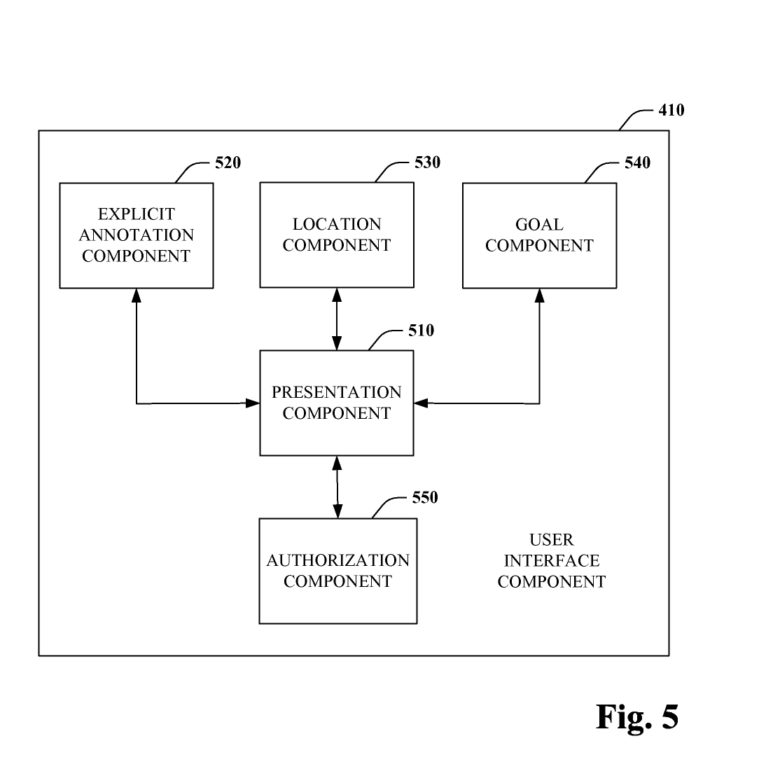

Referring to FIG. 5, a representative user interface component 410 is depicted according to an aspect of the disclosure. The interface component 410 includes a presentation component 510 that presents data including but not limited to alphanumeric characters, graphics, audio and/or video to facilitate user interaction. The presentation can be dependent on the functionality attempted to be employed and further influenced by specialized components including components 520-540. The explicit annotation component 520 facilitates receipt of explicit trail annotations from users. Accordingly, a trail can be presented and tools provided to enable a user to add a label to the trail, like “tough hill.” The location component 530 provides specialized interface mechanisms to allow a user to locate or lookup trails, for example via browsing and/or search. Similarly, the goal component 540 facilitates entry of user goals, as will be discussed further infra.

The presentation component 510 is communicatively coupled to the authorization component 550. The authorization component 550 controls access to information based on a user's identity, role or position for instance. In other words, the presentation component 510 can employ authorization component 510 to determine which information and/or how information is presented based on the user. Further, the authorization component 550 can facilitate query and receipt of identifying data from users to enable authentication and authorization. For example, a user may be required to provide a user name and pass code. Additionally or alternatively, the authentication component 540 can communicate with other components to request and receive information including but not limited to components that facilitate biometric authentication based on user characteristics and/or behavior (e.g., fingerprints, palm prints, iris pattern, voice, typing pattern . . . ). Once identified, access to data can be restricted. In this manner, users may designate their trails as private such that only they are able to view and annotate their trails. Users may also designate some or all trails as public such that a community of other users is able to view their trails. Of course, there can be a hybrid between completely private and completely public. In such an instance, a user may identify a particular group of people with which to share data.

Continuing with the previous exercise example, John can log on to a website and view his last run visualized on a map interface via interface component 41 0. Furthermore, the system could automatically annotate the run with his speed, amount of hill ascent and descent, the number of starts and stops and his heart rate. Breakdowns of his route can also be provided in various segments. Thus, John is able to see that his heart rate hit a sustained peak when climbing a hill at about the midpoint of his run. John can then click on the map and at the peak of the hill add the manual text annotation “brutal hill” to remind him. John is also able to access the full history of his routes in order to assess his personal progress over time. He sees that his runs have been getting longer over the past few months and chooses to make all his routes, including all annotations, public so that other members of the community can see his route.

Later that afternoon, Megan logs into the website in order to find a route for her evening run. She searches the data store for runs that are 10% harder than her current average run and that start within a mile of her house. The system returns John's run because the average heart rate is slightly higher than that of Megan's average run, the starting point is within Megan's specified distance of here house and because John made his run public. She sees John's annotation “brutal hill” and thinks to herself that she will tackle it if she is felling good or otherwise take an alternative she sees on the map. She decides that this will be a good run and clicks on an interface link “download to phone” so that the route will be ready for her on her phone. Her download of this run is fed back to the system for future reporting on the popularity of the run. That evening, just as she is about to start running, she opens the run on her mobile phone so that she can see the map and follow along during the run. Additionally or alternatively, she may have directions provided audibly as needed to guide her. For example, the instructions can state “Turn left at the next street” or “‘brutal hill’ straight ahead in half a mile.”

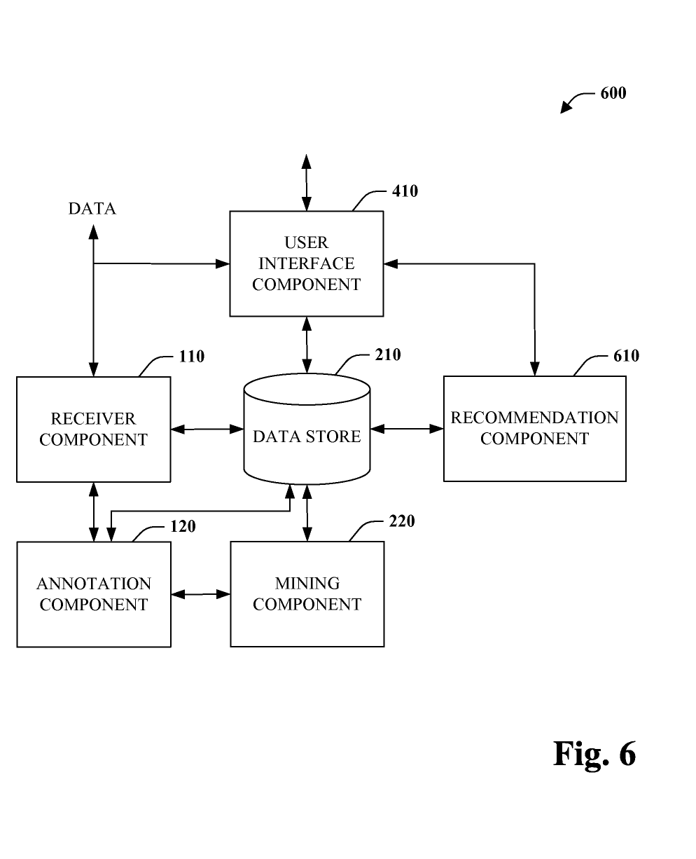

FIG. 6 depicts a system 600 of trail recommendation in accordance with an aspect of the disclosure. Similar to system 400 of FIG. 4, system 600 includes the receiver component 110, annotation component 120, data store 210, data mining component 220 and user interface component 410. In sum, these components cooperate to facilitate automatic and/or explicit route annotation as well as interaction therewith. Further provided is the recommendation component 610 communicatively coupled to the data store 210 and the user interface component 410.

The recommendation component 610 is operable to generate recommendations, suggestions or the like with respect to trails. More specifically, the recommendation component 610 can recommend a trail to a user based on characteristics associated with the user as well as trail annotations. For instance, a route could be suggested to a cyclist based on his geographical location, desired distance, intensity, etc. and annotated routes persisted by other users. In this instance, collaborative filter algorithms can be employed by the recommendation component 610 to recommend routes.

Furthermore, the recommendation component 610 can afford goal directed recommendations, suggestions and the like. Typical collaborative filtering algorithms can be employed to make broad recommendations. As an example in the running context, the recommendation component 610 would make the following recommendation to a user whose average run is six miles: “Other people who run 6 miles also ran the following runs: Run #1, 5 miles, Run #2, 7 miles, Run #3, 4.5 miles . . . ” In other words, the component does not account for the user's goal to run longer distances and instead recommends shorter and longer routes with equal weight. Additionally or alternatively, the recommendation component 610 can take into account user goals (or other information about the user, such as his/her skill level, injuries, personal preferences, etc . . . ) persisted in the data store 210 and/or provided by the user interface component 410. This can be accomplished in a variety of manners including, without limitation, collaborative filters, matching algorithms and/or weighting the result set of recommended routes according to parameters set by the user and/or automatically. The result is that users can employ automatic suggestions to improve their personal performance in accordance with designated goals. Users might discover new routes that suit their needs thanks to the recommendations provided by the system. Finally, the community aspects of the invention would allow users to meet exercise partners with similar schedules, fitness levels and preferences.

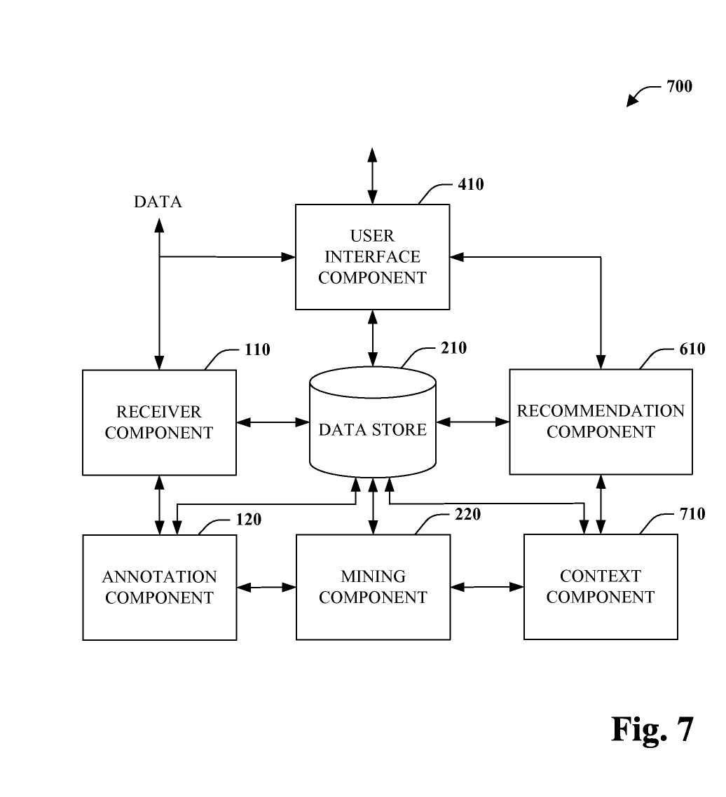

FIG. 7 illustrates a trail system 700 in accordance with an aspect of this detailed description. System 700 includes the same components of system 600 of FIG. 6, namely the receiver component 110, annotation component 120, data store 210, mining component 220, user interface component 410 and recommendation component 610. As previously described, these components can facilitate trail annotation and recommendation. System 700 also includes context component 710 communicatively coupled to one or more of the recommendation data store 210, the recommendation component 610 and/or the mining component 220. The context component 710 receives, retrieves or otherwise acquires contextual information for use by the system. For instance, the context component 710 can retrieve information from a third party source and inject such information into the annotation and recommendation functionality. By way of example, the context component 710 can obtain outdoor weather, temperature and/or humidity data, which can be germane in an exercise context, among other things. This information can be persisted to store 210 and/or employed by the mining component 220 and/or the annotation component 120 to annotate a trail with such information. Similarly, contextual information can be utilized by the recommendation component 610 to make suggestions or recommendations regarding trails. In another example, context information can include real-time or substantially real-time events (e.g., parade, traffic accident . . . ). Such information can be utilized to influence trail recommendation, for instance to suggest trails that avoid such events.

The aforementioned systems have been described with respect to their interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the mining component 120 can employ such mechanisms to facilitate identification of useful information from a myriad of raw sensor data.

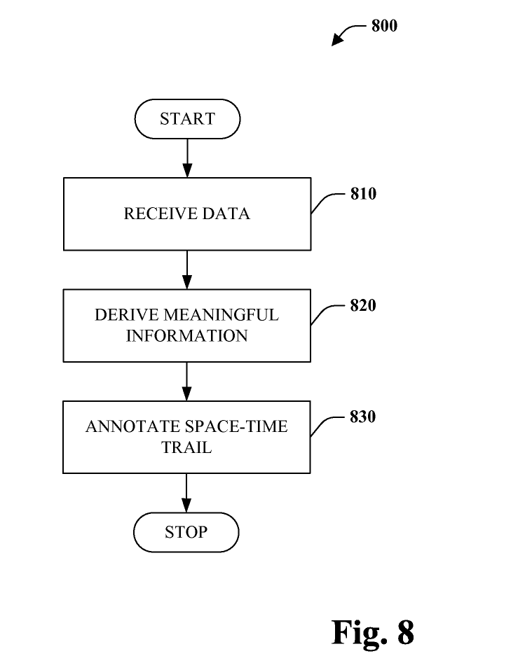

In view of the exemplary systems described sura, methodologies that may be implemented in accordance with the disclosed subject matter will be better appreciated with reference to the flow charts of FIGS. 8-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a trail annotation method 800 is shown in accordance with an aspect of the disclosure. At reference numeral 810, data is received. By way of example and not limitation, a plurality of data from raw sensors can be acquired alone or in conjunction with a space-time trail. Such data can capture at least one of user state, environmental state and/or geographic location. Contextual data can also be supplied from third party services or the like. At numeral 820, meaningful information can be derived from the received data. In one instance, one or more algorithms can be applied to the data to extract useful information. A related space-time trail can be annotated at 830 with the meaningful information. For instance, heart rate can be extracted from raw ECG data and utilized to annotate a running route with an individual's heart rate at various points along the route. Method 800 can thus utilize implicit passive data to automatically annotate a trail with valuable information.

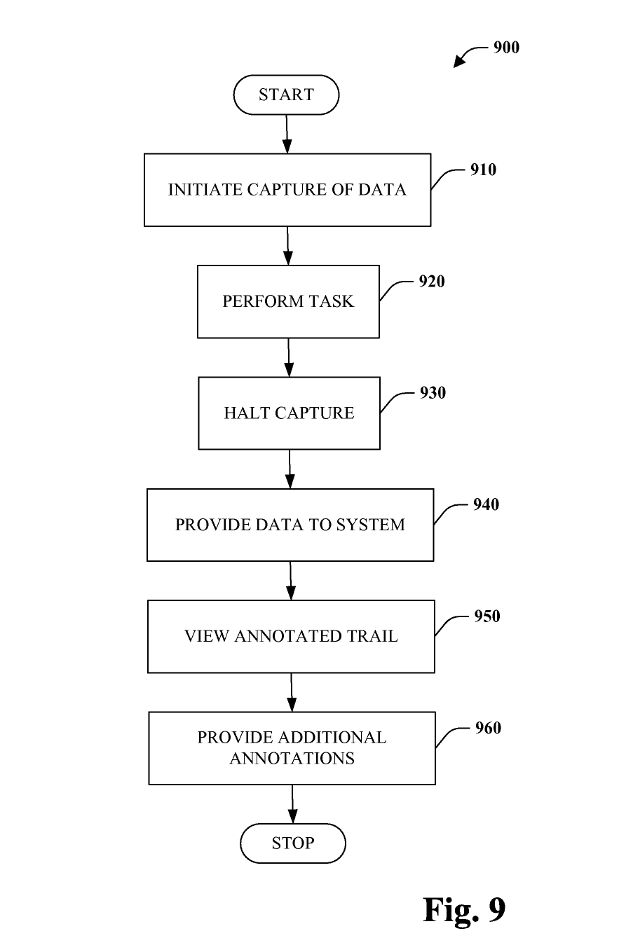

FIG. 9 illustrates a method 900 of annotating a trail in accordance with an aspect of the disclosure. At reference numeral 910, data capture can be initiated by a user, for example. A task or action is then taken or permitted to occur at numeral 920. Data capture can be subsequently be halted at numeral 930. In accordance with an aspect provided herein, actions 910-930 can be performed with respect to a mobile device. Captured data can be provided to a trail system at 940. The system can then annotate a trail with meaningful information derived from the captured data. At reference numeral 950, an annotated trail is viewed. At reference 960, additional annotations are provided with respect to the annotated trail. For instance, users can add explicit notations to the trail.

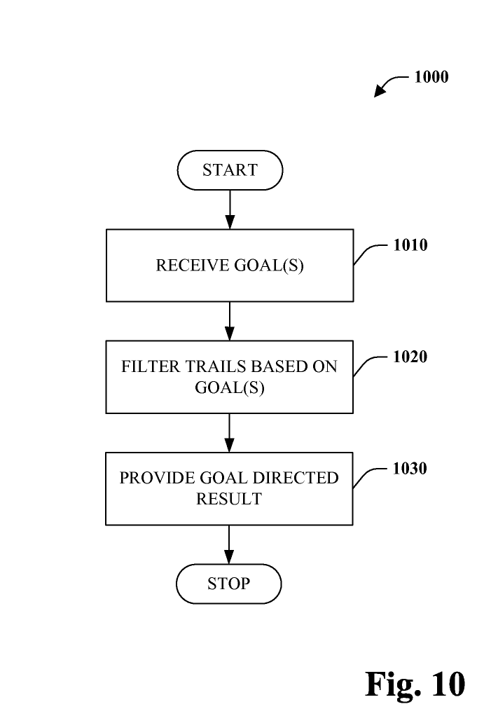

FIG. 10 illustrates a trail recommendation method 1000 according to an aspect of the disclosure. At reference numeral 1010, one or more goals are received for instance from a particular user. The goal can be related to desired performance, for example. At numeral 1020, space-time trails are filtered based on the received goal(s). In one instance, collaborative filters and/or matching algorithms can be employed to identify trails that may interest a user based on his/her goal(s). At reference numeral 1030, goal directed results are provided.

The aforementioned systems and methods have a myriad of disparate applications in addition to the sports/exercise applications utilized to facilitate clarity and understanding with respect to aspects of the disclosure. The systems and methods generally relate to collection, analysis, sharing and presentation of space-time trails. Accordingly, aspects can be employed with respect to online communities in which location aware mobile devices are employed. By way of example, industrial users might use disclosed technologies to ensure that maintenance is being done uniformly around a plant. Typically, people tend to perform maintenance when something interesting catches their attention or is interesting, thus not necessarily spreading their attention around maintenance issues. Aspects of the disclosure can be utilized to annotate and make recommendations with respect to maintenance routes. Other applications can pertain to security, retail and/or navigation. For instance, if a vehicle's speed is zero and the driver's heart rate and temperature are high, this information can be utilized to recommend different routes to other drivers. Still further yet, it is to be noted that space-time trails need not be physical. Also contemplated are digital paths and/or virtual environments. For example, a trail can correspond to a digital trace.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

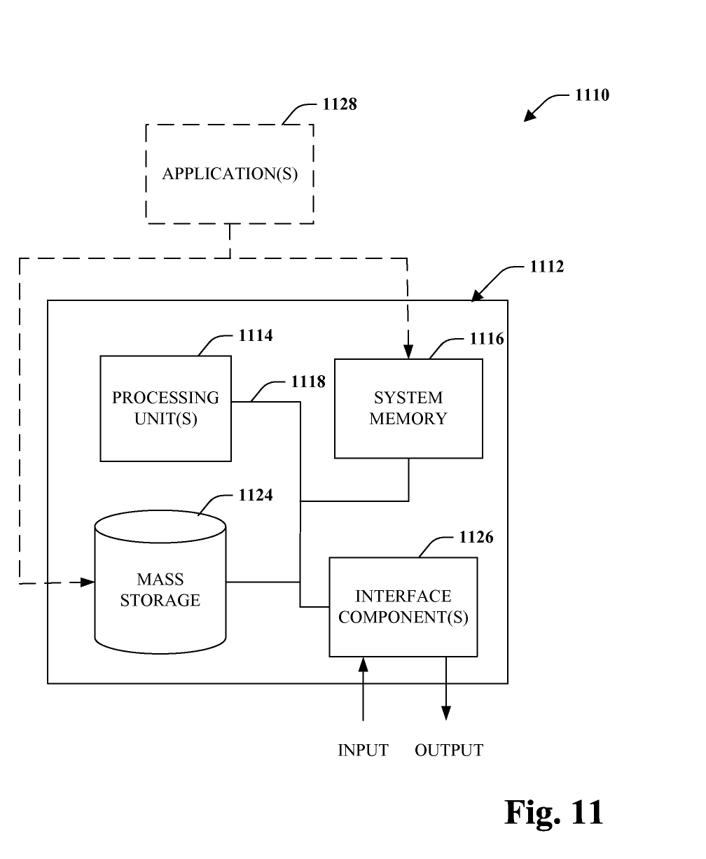

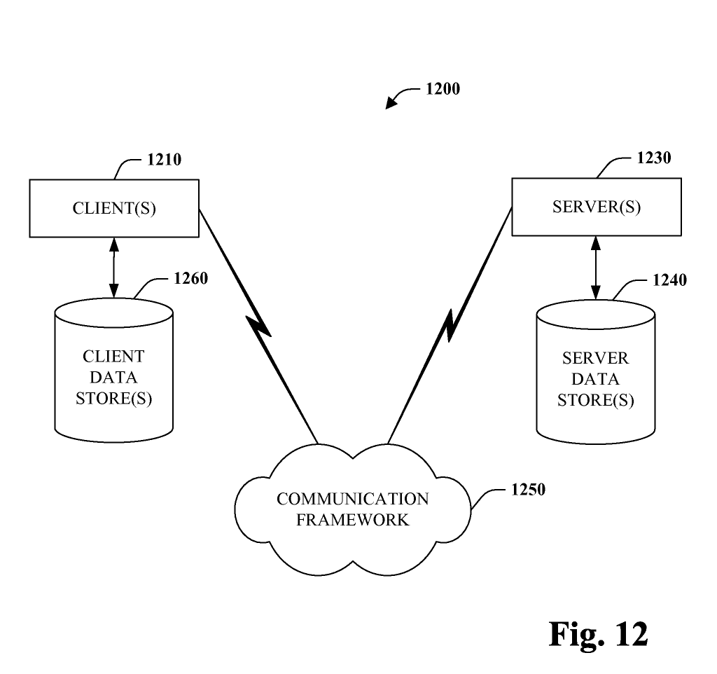

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ). microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116 and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory or memory stick. In addition, mass storage 1124 can include storage media separately or in combination with other storage media.

FIG. 11 provides software application(s) 1128 that act as an intermediary between users and/or other computers and the basic computer resources described in suitable operating environment 11 10. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which aspects of the disclosure can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

In one instance, client(s) 1210 can correspond to one or more location-aware mobile devices including a local data store 1260 for storing trails and/or sensor data. Server(s) 1230 can correspond to one or more data processing servers and/or a web server. For example, a client device 1210 can provide trail and/or sensor data to a web server 1230 via communication framework 1250. The web server 1230 can then provide the data to a backend server 1230 for processing. The backend server 1230 can apply various algorithms to sensor data to generate valuable information that can subsequently be utilized to annotate a trail via metadata and persisted to server data store 1240. Server(s) 1230 can make trails available for search and/or facilitate provisioning of recommendations including goal-directed recommendations. Of course, variations in processing are contemplated including executing all functionality on the client(s) 1210. Further yet, processing may be intelligently distributed between client(s) and server(s) based on computational power and availability thereof.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A space-time trail annotation system, comprising:
a receiver component that receives sensor data; and
an annotation component that automatically annotates a space-time trail with information derived from the sensor data.

2. The system of claim 1, further comprising a mining component that employs one or more data mining algorithms over the sensor and/or other stored data to extract the annotation information.

3. The system of claim 1, further comprising a capture component that captures and provides sensor data to the receiver component.

4. The system of claim 3, the capture component forms part of a mobile device including at least one of a mobile phone, personal digital assistant and media player.

5. The system of claim 1, further comprising an interface component that facilitates active route annotation by a user.

6. The system of claim 1, further comprises a recommendation component that employs one or more collaborative filters and/or matching techniques to generate one or more trail recommendations.

7. The system of claim 6, the recommendation component generates one or more goal-directed trail recommendations.

8. The system of claim 1, further comprising an interface component that renders annotated paths.

9. The system of claim 1, further comprising a context component that supplies context information to the annotation component for use in route annotation.

10. The system of claim 1, the space-time trail is a digital trace.

11. A system that facilitates route annotation, comprising:
means for receiving data associated with user state and location; and
means for automatically annotating a route with information derived from the data.

12. The system of claim 11, further comprising a means for affording at least one goal-directed recommendation based on route annotation.

13. A method for annotating physical routes, comprising:
receiving sensor data indicative of user state, environmental state and geographical location;
extracting meaningful information from the data; and
annotating a route automatically with the extracted information.

14. The method of claim 13 extracting meaningful information, comprising executing of one more data mining algorithms.

15. The method of claim 14, further comprising executing one or more of an algorithm that extracts a person's pace, road surface smoothness and/or cycling cadence from raw acceleration data.

16. The method of claim 14, further comprising executing an algorithm that extracts a person's heart rate from raw ECG data.

17. The method of claim 14, further comprising persisting annotated routes to a network accessible database.

18. The method of claim 17, further comprising displaying the annotated routes to users in accordance with associated permissions.

19. The method of claim 1, further comprising generating route recommendations based on user performance goals and/or user profile.

20. The method of claim 19, further comprising generating route recommendations based on context information associated with the user, location and/or third-party events.
